(19) United States
(12) Patent Application Publication
(10) Pub. No.: US 2024/0013114 A1
(43) Pub. Date: Jan. 11, 2024

(54) SERVER AND POWER CONDITIONING SYSTEM

(71) Applicant: TOYOTA JIDOSHA KABUSHIKI KAISHA, Toyota-shi Aichi-ken (JP)

(72) Inventors: Atsushi Okubo, Nisshin-shi Aichi-ken (JP); Kiyonori Yoshida, Toyota-shi Aichi-ken (JP); Kotomi Asano, Toyota-shi Aichi-ken (JP); Tamaki Ozawa, Toyota-shi Aichi-ken (JP); Yusuke Saigo, Toyota-shi Aichi-ken (JP)

(73) Assignee: TOYOTA JIDOSHA KABUSHIKI KAISHA, Toyota-shi Aichi-ken (JP)

(21) Appl. No.: 18/306,589

(22) Filed: Apr. 25, 2023

(30) Foreign Application Priority Data
Jul. 11, 2022 (JP) 2022-111181

(51) Int. Cl. G06Q 10/0631; G06Q 50/06

(52) U.S. Cl. CPC G06Q 10/06315; G06Q 50/06

(57) ABSTRACT

A server notifies a user of a vehicle that is able to participate in DR. The server includes a communication device and a processing device. The communication device communicates with a provider server that stores information indicating an execution period and an execution location of at least one job given by a provider. The processing device performs a process of inquiring the provider server about whether the at least one job includes a target job through the communication device. The target job is a job of which the execution period is included in a DR period and the execution location is in a vicinity area of a DR location. When the at least one job includes the target job, the processing device performs a notification process of notifying the user of target job information indicating the execution period and the execution location of the target job.

### CROSS-REFERENCE TO RELATED APPLICATION

This application claims priority to Japanese Patent Application No. 2022-111181 filed on Jul. 11, 2022, incorporated herein by reference in its entirety.

### BACKGROUND

### 1. Technical Field

The present disclosure relates to a server and a power conditioning system.

### 2. Description of Related Art

Japanese Patent Application Publication No. 2020-102025 (JP 2020-102025 A) discloses a charging processing system. This charging processing system includes a power supply facility, a vehicle, and a server. The power supply facility is provided outside of the vehicle. The vehicle performs external charging of charging an onboard power storage device using electric power supplied from the power supply facility. The server is configured to notify a user of the vehicle.

### SUMMARY

Demand response (DR) for adjusting electric power demand-supply balance in a power grid has been studied in association with a virtual power plant (VPP). DR is a technique of requiring power-conditioning resources of consumers to change (for example, increase) demand for electric power.

When a vehicle in which a power storage device is mounted is used as a power-conditioning resource, the vehicle may participate in DR through external charging. The vehicle is connected to an electric power facility in a period in which the vehicle participates in DR (DR period). Accordingly, there is a likelihood that a user of the vehicle will not freely use the vehicle in the DR period and have an idle time until the vehicle is available after the DR period has expired.

The present disclosure provides a server and a power conditioning system that enable effective utilization of an idle time of a user in a DR period while contributing to adjustment of electric power demand-supply balance.

According to an aspect of the present disclosure, there is provided a server configured to notify a user of a vehicle that is able to participate in demand response for adjusting electric power demand-supply balance in a power grid through external charging of charging an onboard power storage device using an electric power facility outside of the vehicle. The server includes a storage device, a communication device, and a processing device. The storage device stores information indicating a demand-response period which is a period in which the vehicle participates in the demand response and a demand-response location which is a location of the electric power facility used for the vehicle to participate in the demand-response. The communication device communicates with a provider server that stores information indicating an execution period and an execution location of at least one job given by a provider. The processing device performs a process of inquiring the provider server about whether the at least one job includes a target job through the communication device. The target job is a job of which the execution period is included in the demand-response period and the execution location is in a vicinity area of the demand-response location. When the at least one job includes the target job, the processing device is configured to perform a notification process of notifying the user of target job information indicating the execution period and the execution location of the target job.

With this configuration, the user is motivated such that the user implements the target job in a vicinity area of the demand-response location in the demand-response period. Accordingly, it is possible to effectively utilize an idle time of a user in the demand-response period. As a result, it is possible to enable effective utilization of an idle time of a user in a demand-response period while contributing to adjustment of electric power demand-supply balance.

The target job information may include information indicating a required time for the target job. The processing device may be configured to set a command value of charging electric power of the onboard power storage device in the demand-response period. When the user implements the target job, the processing device may be configured to set the command value to be higher when the required time is short than when the required time is long.

With this configuration, when the required time is short, an amount of charging electric power is higher than when the required time is long. Accordingly, participation of the vehicle in the demand response ends earlier. As a result, it is possible to shorten a standby time of the user until participation of the vehicle in the demand response ends after the user has completed the target job.

When the user performs an operation for desiring extension of the demand-response period after starting the target job, the processing device may be configured to extend the demand-response period.

A user may desire extension of the demand-response period depending on the type of the target job. By employing this configuration, it is possible to satisfy the user's desire while contributing to adjustment of electric power demand-supply balance for a longer time.

The processing device may be configured to acquire a user image generated by an imaging device that images the user from the imaging device and to perform an attribute determining process of determining attributes of the user based on the user image. When there is a plurality of target jobs, the processing device may be configured to select a proposed job which is proposed to the user out of the plurality of target jobs based on a result of the attribute determining process and to perform the notification process by notifying the user of the target job information of the proposed job.

With this configuration, a proposed job is selected based on the user's attributes. As a result, it is possible to notify the user of a target job suitable for the user's attributes.

The notification process may include displaying the target job information on a display device mounted in the vehicle or a display device of a terminal device of the user.

According to another aspect of the present disclosure, there is provided a power conditioning system including a vehicle and a server. The vehicle is able to participate in demand response for adjusting electric power demand-supply balance in a power grid through external charging of charging an onboard power storage device using an electric power facility outside of the vehicle. The server is configured to notify a user of the vehicle. The server includes a storage device, a communication device, and a processing device. The storage device is configured to store information indicating a demand-response period which is a period in which the vehicle participates in the demand response and a demand-response location which is a location of the electric power facility used for the vehicle to participate in the demand-response. The communication device is configured to communicate with a provider server that stores information indicating an execution period and an execution location of at least one job given by a provider. The processing device is configured to perform a process of inquiring the provider server about whether the at least one job includes a target job through the communication device. The target job is a job of which the execution period is included in the demand-response period and the execution location is in a vicinity area of the demand-response location. When the at least one job includes the target job, the processing device is configured to perform a notification process of notifying the user of target job information indicating the execution period and the execution location of the target job.

According to the present disclosure, it is possible to enable effective utilization of an idle time of a user in a DR period while contributing to adjustment of electric power demand-supply balance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a power conditioning system according to an embodiment;

FIG. 2 is a diagram illustrating a positional relationship between a DR location of a vehicle and an execution location of a job;

FIG. 3 is a diagram illustrating a detailed configuration of a vehicle;

FIG. 4 is a diagram illustrating an example of a database stored in a provider server;

FIG. 5 is a diagram illustrating an example of a screen which is displayed on a human-machine interface (HMI) device when a user U is notified of target job information;

FIG. 6 is a flowchart illustrating an example of a routine which is performed by a processing device of a server according to the embodiment;

FIG. 7 is a diagram illustrating an effect that participation of a vehicle in DR ends earlier because a command value CV is set to be higher;

FIG. 8 is a flowchart illustrating an example of a routine which is performed by a processing device of a server according to Modified Example 1;

FIG. 9 is a diagram illustrating an example of a screen which is displayed on the HMI device in an execution period of a target job; and

FIG. 10 is a flowchart illustrating an example of a routine which is performed by a processing device of a server according to Modified Example 3.

### DETAILED DESCRIPTION OF EMBODIMENTS

An embodiment of the present disclosure will be described below in detail with reference to the accompanying drawings. The same or corresponding elements in the drawings will be referred to by the same reference signs and description thereof will not be repeated. In the following description, a vehicle that can perform external charging is used as an example of a power source.

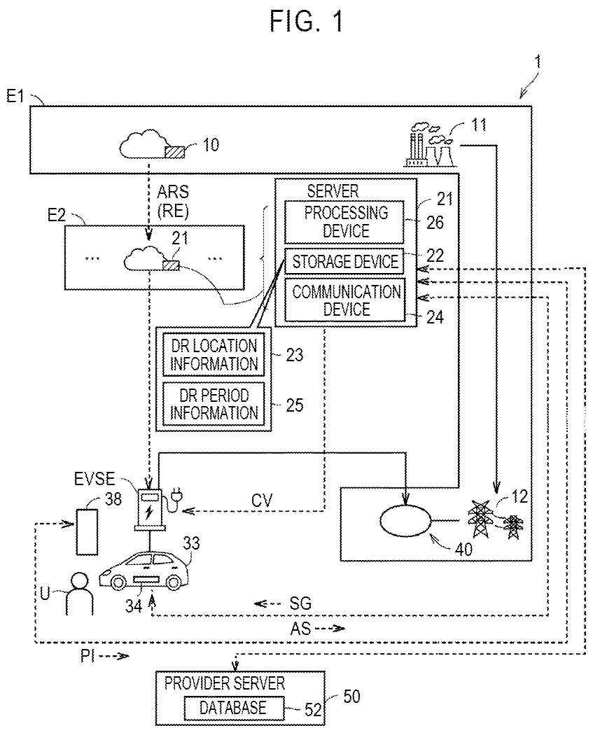

FIG. 1 is a diagram illustrating a configuration of a power conditioning system according to an embodiment. Referring to FIG. 1, the power conditioning system 1 includes a power company system E1, an aggregation system E2, an electric power facility EVSE, a vehicle 33, a mobile terminal 38, and a provider server 50.

The power company system E1 is managed by a power company and includes a server 10, a power plant 11, a power transmission and distribution facility 12, and a power grid 40. The server 10 manages electric power demand-supply balance in the power grid 40. The power plant 11 supplies electric power generated by a power generator to the power transmission and distribution facility 12. The power transmission and distribution facility 12 supplies electric power supplied from the power plant 11 to the power grid 40.

The aggregation system E2 includes a server 21. The server 21 is managed by an aggregator and receives an adjustment request signal ARS from the power company system E1. The adjustment request signal ARS includes information indicating a power-conditioning period, a power-conditioning area, and an amount of conditioning-required electric power RE. The power-conditioning period and the power-conditioning area are a period and an area in which power conditioning is required. The amount of conditioning-required electric power is an amount of electric power of which conditioning (for example, increasing) is required in the power-conditioning area in the power-conditioning period.

The server 21 divides the amount of conditioning-required electric power RE into n amounts (n≥2) in response to reception of the adjustment request signal ARS. The server 21 allocates the n divided amounts of electric power to n power-conditioning resources. In this embodiment, the n power-conditioning resources include the vehicle 33 that can perform external charging and a plurality of different power-conditioning resources (not illustrated).

The server 21 requests the vehicle 33 to participate in DR by receiving an allocated amount of electric power (an allocated electric power) at the DR location in the DR period. Specifically, the server 21 transmits a signal SG to the vehicle 33 and requests the vehicle 33 to participate in DR using the signal SG. The server 21 may transmit the signal SG to a mobile terminal 38 of a user U of the vehicle 33 in order to request the vehicle 33 to participate in DR. In this example, the DR period corresponds to a power-conditioning period and is a period in which the vehicle 33 participates in DR. The DR location is a location at which a power-conditioning resource participates in DR and corresponds to a location of the electric power facility EVSE used for the vehicle 33 to participate in DR in this example.

When the user U of the vehicle 33 approves participation in DR, an approval signal AS indicating the approval is transmitted from the vehicle 33 (or the mobile terminal 38) to the server 21. As a result, a contract is made between the user U of the vehicle 33 and the aggregator. This contract includes information indicating an allocated electric power.

The server 21 includes a storage device 22, a communication device 24, and a processing device 26. The storage device 22 includes a random access memory (RAM) and a read only memory (ROM) (none of which are illustrated). The RAM serves as a working memory. The ROM stores a program which is executed by the processing device 26 and data. The data includes DR location information 23 and DR period information 25. The DR location information 23 and the DR period information 25 include information indicating a DR location and a DR period for each power-conditioning resource.

The communication device 24 is configured to communicate with a device outside of the server 21. The device is, for example, the server 10, the vehicle 33, the mobile terminal 38, the electric power facility EVSE, or the provider server 50 (which will be described later).

The processing device 26 includes a processor such as a central processing unit (CPU). For example, the processing device 26 is configured to perform a process of setting a command value CV for charging electric power of the power storage device 34 of the vehicle 33 (electric power supplied from the electric power facility EVSE to the power storage device 34) in the DR period. The processing device 26 transmits the command value CV to the electric power facility EVSE via the communication device 24.

The electric power facility EVSE is connected to the power grid 40 and is configured to supply electric power to the vehicle 33. The electric power facility EVSE is used for the vehicle 33 to participate in the DR. The electric power facility EVSE includes a communication device (not illustrated) and is configured to receive the command value CV from the server 21 via the communication device.

The vehicle 33 is an electric vehicle in which the power storage device 34 is mounted. The vehicle 33 is configured to participate in the DR by performing external charging using the electric power facility EVSE. The detailed configuration of the vehicle 33 will be described later.

The mobile terminal 38 is, for example, a smartphone, and a terminal device that is carried by a user U. The mobile terminal 38 includes a camera and a display device (none of which are illustrated).

The provider server 50 manages an offer of at least one (a plurality of, in this example) job which is given by a provider. The job is, for example, a part-time job. The provider server 50 stores a database 52. The database 52 includes job information (which will be described later) indicating an execution period and an execution location of at least one job given by the provider. The structure of the database 52 will be described later in detail.

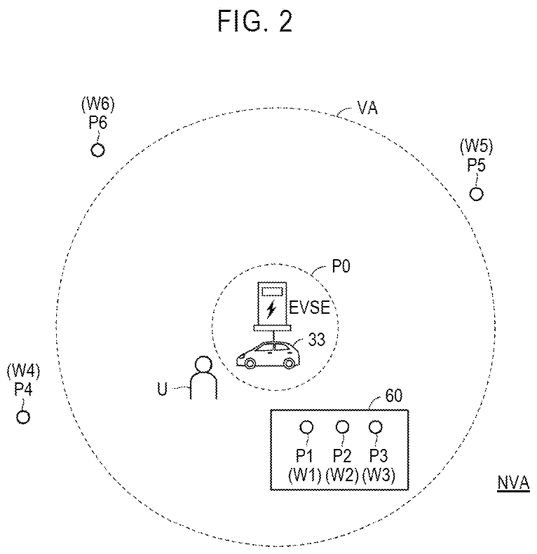

FIG. 2 is a diagram illustrating a positional relationship between a DR location of the vehicle 33 and an execution location of a job.

Referring to FIG. 2, the DR location of the vehicle 33 is a location P0. Locations P1 to P6 are execution locations of jobs W1 to W6 which are given by the provider. The jobs W1 to W3 are executed in a department store 60.

The locations P1 to P3 are located in a vicinity area VA of the location P0. The vicinity area VA is an area within a predetermined distance (for example, 1 km) from the location P0 in this example. On the other hand, the locations P4 to P6 are non-vicinity areas NVA which are areas other than the vicinity area VA.

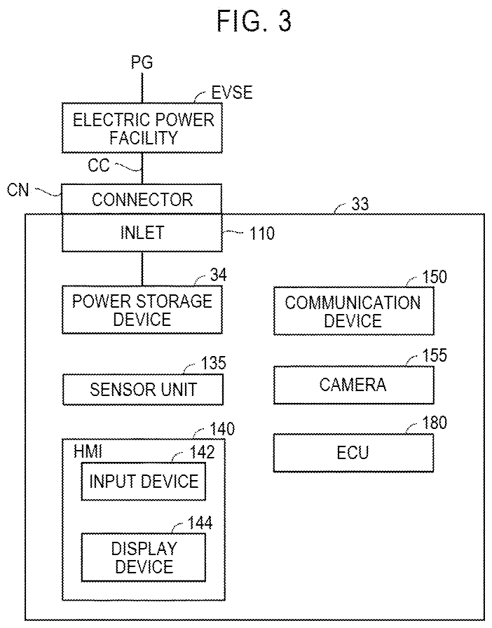

FIG. 3 is a diagram illustrating the detailed configuration of the vehicle 33. Referring to FIG. 3, the vehicle 33 includes an inlet 110, a sensor unit 135, and an HMI device 140 in addition to the power storage device 34. The vehicle 33 further includes a communication device 150, a camera 155, and an electronic control unit (ECU) 180.

A power cable CC extending from the electric power facility EVSE and a connector CN thereof are connected to the inlet 110. The inlet 110 receives electric power from the electric power facility EVSE via the power cable CC and the connector CN. The electric power received by the inlet 110 is supplied to the power storage device 34. A power converter may be provided between the inlet 110 and the power storage device 34.

The sensor unit 135 detects a value of charging electric power of the power storage device 34 while the vehicle 33 is performing external charging.

The HMI device 140 is, for example, a touch screen and includes an input device 142 and a display device 144. The input device 142 receives an input of various operations by a user U. The display device 144 displays various screens. A specific example of the screens will be described later in detail.

The communication device 150 is configured to communicate with a device (for example, the server 21) outside of the vehicle 33. When the inlet 110 is connected to the connector CN, the communication device 150 may be configured to communicate with the electric power facility EVSE by controller area network (CAN) communication.

The camera 155 generates a user image of a user by imaging the user U when the user U is in the vehicle 33.

The ECU 180 controls various devices of the vehicle 33. The ECU 180 causes, for example, the display device 144 to display various screens.

The ECU 180 acquires a user image from the camera 155 or acquires information indicating a detection value from the sensor unit 135. For example, the ECU 180 is configured to transmit the user image to the server 21 via the communication device 150.

The ECU 180 controls external charging of the vehicle 33. When a DR period comes in a state in which the power cable CC and the connector CN are connected to the inlet 110, the ECU 180 outputs a charging start request to the electric power facility EVSE by CAN communication. Accordingly, external charging is started. The ECU 180 determines whether an amount of charging electric power of the power storage device 34 under external charging (an amount of electric power supplied from the electric power facility EVSE to the power storage device 34 under external charging) has reached the allocated electric power on the basis of a detection value from the sensor unit 135. When the amount of charging electric power has reached the allocated electric power, the ECU 180 outputs a charging end request to the electric power facility EVSE. Accordingly, the external charging is ended. As a result, participation of the vehicle 33 in the DR ends.

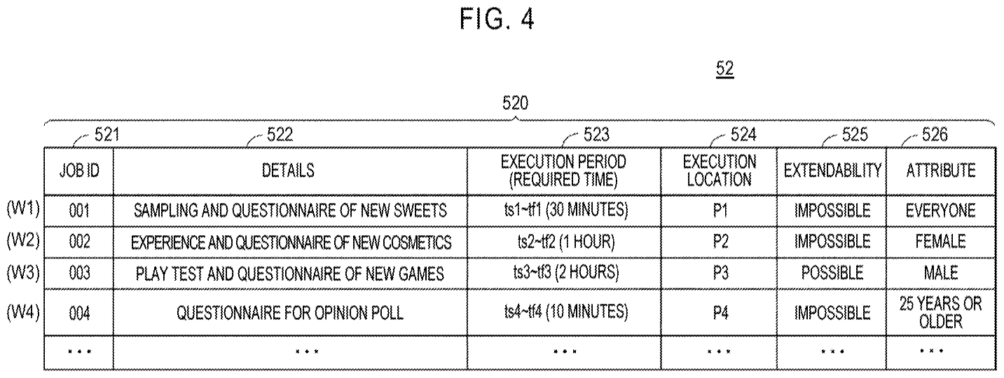

FIG. 4 is a diagram illustrating an example of the database 52 stored in the provider server 50.

Referring to FIG. 4, the database 52 includes job information 520. The job information 520 indicates various types of information of at least one job (a plurality of jobs in this example). Specifically, the job information 520 includes an identification (ID) 521, detailed information 522, execution period information 523, execution location information 524, extendability information 525, and attribute information 526.

The ID 521 indicates identification information of a corresponding job. The detailed information 522 indicates details (contents) of a corresponding job. The execution period information 523 indicates an execution period of a corresponding job. The execution period information 523 also indicates a required time for a corresponding job. The execution location information 524 indicates an execution location of a corresponding job. The extendability information 525 indicates extendability of a corresponding job. The attribute information 526 indicates appropriate sex/age of a corresponding job.

The vehicle 33 is connected to the electric power facility EVSE in a period in which the vehicle 33 participates in the DR (DR period). Accordingly, the user U cannot freely use the vehicle 33 in the DR period and there is a likelihood that there will be an idle time until the vehicle 33 becomes available after the DR period has expired.

The server 21 according to this embodiment has a configuration for coping with such a problem. Specifically, the processing device 26 performs a process of inquiring the provider server 50 about whether at least one job indicated by the job information 520 includes a target job via the communication device 24. The target job is a job of which the execution period is in the DR period and the execution location is in the vicinity area VA.

For example, the jobs W1 to W3 (see FIG. 2) are implemented in the vicinity area VA and thus may be the target job. On the other hand, the jobs W4 to W6 are implemented in the non-vicinity area NVA and thus may not be the target job.

In response to the inquiry, the provider server 50 determines whether a target job is present (that is, whether at least one job indicated by the job information 520 includes a target job). Specifically, the provider server 50 acquires the DR location information 23 and the DR period information 25 associated with the vehicle 33 from the server 21 and performs the determination process on the basis of the result of acquisition, the execution period information 523, and the execution location information 524 (FIG. 4). When a target job is present, the provider server 50 notifies the server 21 of that gist.

When that notification is received, the processing device 26 performs a notification process of notifying the user U of target job information indicating an execution period and an execution location of the target job. The notification process may be performed by screen display or voice. The target job information corresponds to the execution period information 523 (also indicating a required time) and the execution location information 524 of the target job, and may further include the ID 521, the detailed information 522, the extendability information 525, and the attribute information 526 of the target job.

When the notification process is performed as described above, the user U is motivated to implement the target job in the vicinity area VA in the DR period. Accordingly, it is possible to effectively utilize the idle time of the user U in the DR period.

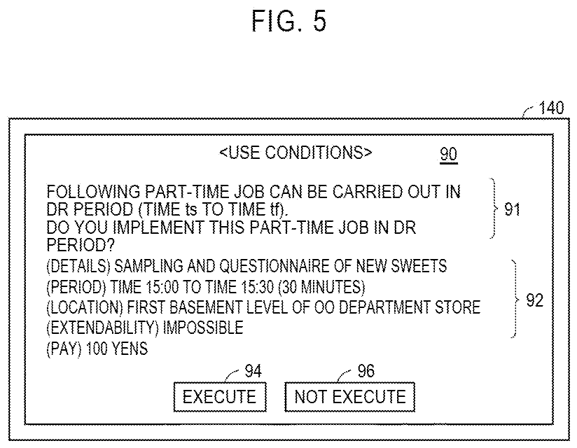

FIG. 5 is a diagram illustrating an example of a screen which is displayed on the HMI device 140 (the display device 144) when the user U is notified of target job information.

Referring to FIG. 5, the screen 90 includes messages 91 and 92 and buttons 94 and 96. The message 91 denotes that the user U can implement a part-time job in the DR period of the vehicle 33 (time is to time tf in this example). The message 91 inquires the user U about whether a part-time job is to be implemented in the DR period. The message 92 denotes various types of information including the target job information.

The button 94 is operated when the user U implements the target job in the DR period. When the button 94 is operated, a signal indicating that gist is transmitted from the vehicle 33 to the provider server 50 via the server 21. Accordingly, implementation of the target job in the DR period is confirmed. On the other hand, the button 95 is operated when the user U is not to implement the target job.

When a plurality of target jobs is present, the server 21 may transmit a signal to the vehicle 33 such that a screen indicating target job information of the plurality of target jobs and enabling the user U to select and implement a desired one of the plurality of target jobs is displayed on the HMI device 140.

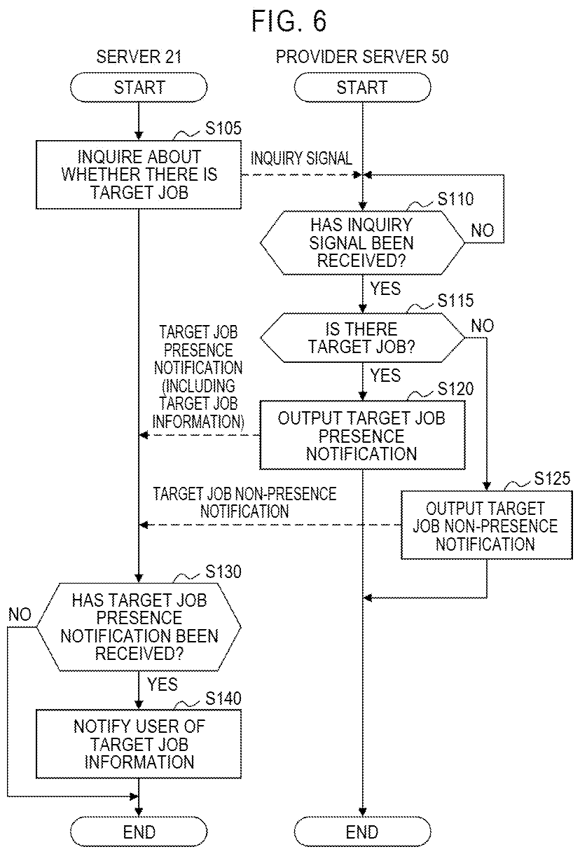

FIG. 6 is a flowchart illustrating an example of a routine which is performed by the processing device 26 of the server 21 according to this embodiment. The flowchart starts when the server 21 receives an approval signal AS (FIG. 1). In the following description, FIGS. 1 to 6 will be appropriately referred to.

Referring to FIG. 6, the server 21 transmits an inquiry signal for inquiring about whether a target job is present to the provider server 50 (Step S105). The inquiry signal includes information indicating the DR location and the DR period of the vehicle 33 (the DR location information 23 and the DR period information 25 of the vehicle 33). Thereafter, the routine of the server 21 proceeds to Step S130.

The provider server 50 determines whether an inquiry signal has been received (Step S110). When an inquiry signal has not yet been received (NO in Step S110), the provider server 50 performs this determination process until the signal is received. On the other hand, when the provider server 50 has received the inquiry signal (YES in Step S110), the routine of the provider server 50 proceeds to Step S115.

The provider server 50 determines whether a target job is present (that is, when at least one job indicated by the job information 520 includes a target job). Specifically, the provider server 50 determines whether an execution period indicated by the execution period information 523 is in the DR period indicated by the inquiry signal and an execution location indicated by the execution location information 524 is in a vicinity area VA of the DR location indicated by the inquiry signal for each ID 521.

When a target job is present (YES in Step S115), the provider server 50 outputs a target job present notification indicating that a target job is present to the server 21 (Step S120). The target job present notification includes information including the execution period information 523 and the execution location information 524 of the target job (target job information). The target job present notification further includes information indicating whether a plurality of target jobs is present and includes target job information for each target job when a plurality of target job is present.

On the other hand, when a target job is not present (NO in Step S115), the provider server 50 outputs a target job non-presence notification indicating that a target job is not present to the server 21 (Step S125). After Step S120 or S125, the routine of the provider server 50 ends.

The server 21 switches the routine based on whether a target job present notification has been received from the provider server 50 (Step S130). When a target job present notification has been received (YES in Step S130), the server 21 notifies the user U of the target job information (Step S140). The server 21 transmits a signal to the vehicle 33, for example, such that the screen 90 is displayed on the HMI device 140. After Step S140, the routine of the server 21 ends. On the other hand, when a target job present notification has not been received, that is, a target job non-presence notification has been received, (NO in Step S130), the server 21 ends the routine.

On the other hand, when a plurality of target jobs is present, the server 21 may notify the user U of the target job information for each job in Step S140.

Even when a plurality of target jobs is present, the server 21 may not notify the user U of the target job information for each job. For example, a signal may be transmitted to the vehicle 33 such that target job information of a job of which the execution location is closest to the DR location or of which pay is the highest out of the target jobs is displayed on the HMI device 140. How the server 21 should select a job of which target job information is notified to the user U out of the target jobs will be also described later in Modified Example 3.

As described above, the server 21 according to this embodiment notifies the user U of target job information when the vehicle 33 participates in the DR. Accordingly, the user U is motivated to implement the target job in the vicinity area VA. As a result, it is possible to effectively utilize an idle time of the user U in the DR period. Accordingly, it is possible to enable effective utilization of an idle time of the user U in the DR period while contributing to adjustment of electric power demand-supply balance.

### Modified Example 1

In Modified Example 1, when a user U implements a target job, the processing device 26 sets a command value CV of charging electric power of the power storage device 34 to be higher when the required time of the target job is short than when the required time is long.

For example, the server 21 sets the command value CV when the required time is less than a reference time to be higher than the command value CV when the required time is equal to or greater than the reference time. The reference time is appropriately predetermined according to the length of the DR period (for example, as a half the length of the DR period). The server 21 inquires the provider server 50 about whether the required time is less than the reference time and performs the setting process based on the result of inquiry.

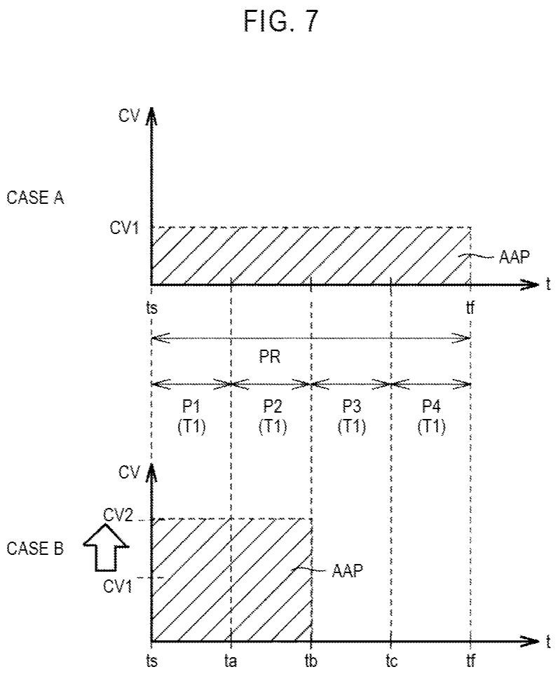

FIG. 7 is a diagram illustrating a case in which participation of the vehicle 33 in the DR ends earlier because the command value CV is set to be high.

Referring to FIG. 7, the period PR is a DR period of from time is to time tf, and a length thereof in this example is 2 hours. The period PR includes periods P1 to P4 as unit periods of the DR period (also referred to as “unit DR periods”). A time length TI of each unit DR period is 30 minutes in this example.

In Case A and Case B, the vertical axis represents the command value CV, and the horizontal axis represents time. An amount of electric power AAP indicates an allocated electric power of the vehicle 33.

In Case A, it is assumed that the user U implements target job of which the required time is 2 hours. In this example, it is assumed that the required time is equal to or greater than the reference time (for example, 1 hour). Accordingly, the command value CV is set to CV1 as a default value. CV1 is a value obtained by dividing the amount of electric power AAP by the length of the period PR. The amount of charging electric power in the power storage device 34 in the DR period reaches the amount of electric power AAP at time tf which is 2 hours later than time ts.

In Case B, it is assumed that the user U implements a target job of which the required time is 30 minutes. In this example, it is assumed that the required time is less than the reference time. Accordingly, the command value CV is set to a value (two times in this example) higher than CV1. Accordingly, the amount of charging electric power doubles that in Case A. As a result, the amount of charging electric power in the power storage device 34 in the DR period reaches the amount of electric power AAP at time tb which is 1 hour later than time ts.

In Case B, since the command value CV is set to be higher in this way, participation of the vehicle in the DR ends earlier than in Case A. That is, implementation of a contract is completed earlier.

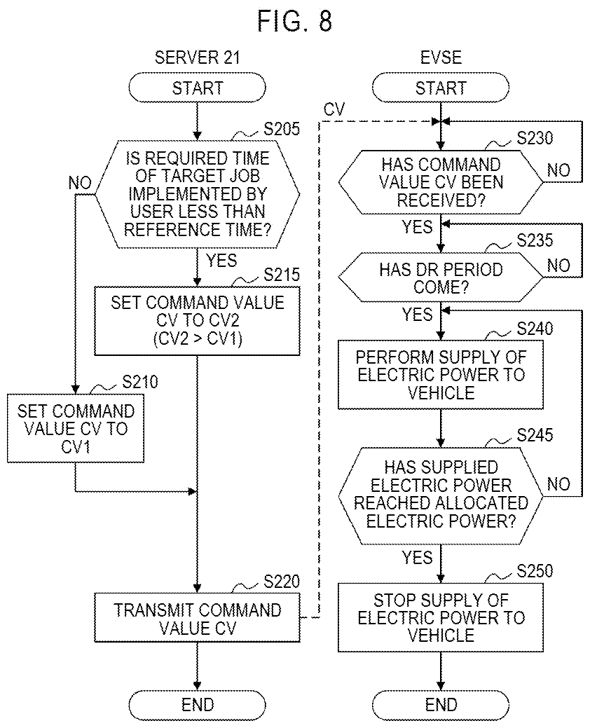

FIG. 8 is a flowchart illustrating an example of a routine which is performed by the processing device 26 of the server 21 according to Modified Example 1. This flowchart starts when the server 21 receives a signal indicating that the button 94 (FIG. 5) has been operated.

Referring to FIG. 8, the server 21 determines whether a required time of a target job which is implemented by the user U is less than the reference time (Step S205). Specifically, the server 21 inquires the provider server 50 about whether the required time is less than the reference time and performs the determination process based on the result of inquiry.

When the required time is not less than the reference time, that is, equal to or greater than the reference time (NO in Step S205), the server 21 sets the command value CV to CV1 (Step S215). On the other hand, when the required time is less than the reference time (YES In Step S205), the server 21 sets the command value CV to CV2 (>CV1) (Step S215). After Step S210 or S215, the server 21 transmits the command value CV to the electric power facility EVSE via the communication device 24 (Step S220). Thereafter, the routine of the server 21 ends.

The electric power facility EVSE determines whether the command value CV has been received (Step S230). When the command value CV has not been received (NO in Step S230), the electric power facility EVSE performs the determination process until the command value CV is received. On the other hand, when the command value CV has been received (YES in Step S230), the electric power facility EVSE causes the routine to proceed to Step S235.

The electric power facility EVSE determines whether the DR period has come (Step S235). When the DR period has not yet come (NO in Step S235), the electric power facility EVSE performs the determination process until the DR period comes. On the other hand, when the DR period has come (YES in Step S235), the electric power facility EVSE performs supply of electric power to the vehicle 33 (Step S250) and causes the routine to proceed to Step S240.

The electric power facility EVSE determines whether an amount of electric power supplied to the vehicle 33 in the DR period has reached the allocated electric power of the vehicle 33 (Step S245). In this example, the electric power facility EVSE performs the determination process based on whether the charging end request has been acquired from the vehicle 33 by CAN communication.

When the amount of supplied electric power has not yet reached the allocated electric power (NO in Step S245), the electric power facility EVSE returns the routine to Step S240. On the other hand, when the amount of supplied electric power has reached the allocated electric power (YES in Step S245), the electric power facility EVSE ends supply of electric power to the vehicle 33 (Step S250).

In Step S205 to S215, the server 21 sets the command value CV to CV1 or CV2 depending on whether the required time of a target job is less than the reference time, but continuously change the command value CV such that the command value CV increases as the required time increases.

According to Modified Example 1, the command value CV is set to be higher when the required time of a target job is short than when the required time is long. Accordingly, participation of the vehicle in the DR ends earlier. As a result, it is possible to shorten a waiting time of the user U until participation of the vehicle 33 in the DR ends after the user U has completed the target job.

### Modified Example 2

When the user U performs an operation of desiring extension of the DR period after having started a target job, the processing device 26 may extend the DR period.

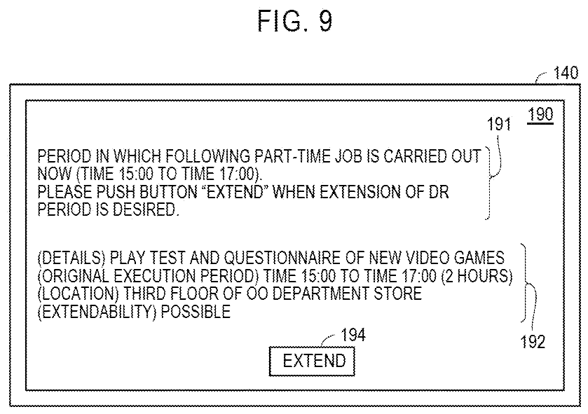

FIG. 9 is a diagram illustrating an example of a screen which is displayed on the HMI device 140 in an execution period of a target job. This screen may be displayed on the display device of the mobile terminal 38. Referring to FIG. 9, the screen 190 includes messages 191 and 192 and a button 194.

The message 191 notifies the user U that the DR period is extendable. The message 192 represents various types of information of a job which is currently performed.

The button 194 is operated by the user U when the user U desires extension of the DR period. When the button 194 is operated, the DR period extends by a predetermined time (for example, 30 minutes). Specifically, an extra period with a length of the predetermined time is added to the DR period which has been originally scheduled, an allocated electric power for the extra period is newly determined by the server 21, and a contract is updated.

In some modes of target jobs, a user may desire extension of the DR period. According to Modified Example 2, the DR period is extended based on a user's desire. Accordingly, it is possible to contribute to adjustment of electric power demand-supply balance for a longer time than the DR period which has been originally scheduled. It is also possible to satisfy the user's desire.

### Modified Example 3

In Modified Example 3, the server 21 performs an attribute determining process of determining (estimating) attributes of the user U based on a user image from the camera 155. The attributes include, for example, age or sex of the user U. The attribute determining process is performed using a known image recognition technique or a known age estimation technique.

When a plurality of target jobs is present, the server 21 selects a proposed job which is proposed to the user U out of the plurality of target jobs based on the result of the attribute determining process. This will be described below in detail. When the number of target jobs is 1, the target job is the same as the proposed job.

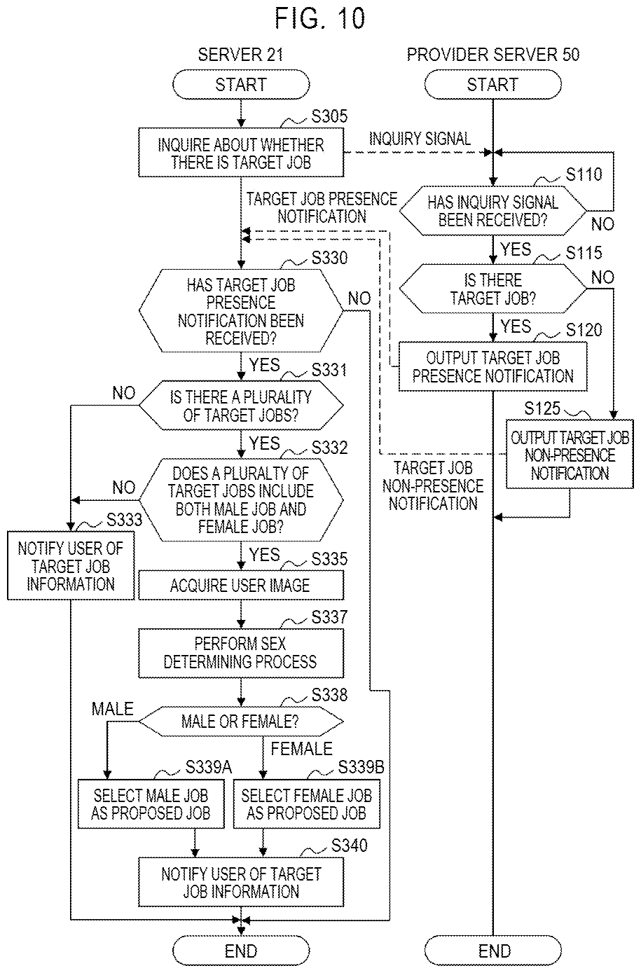

FIG. 10 is a flowchart illustrating an example of a routine which is performed by the processing device 26 of the server 21 according to Modified Example 3. This flowchart starts when the server 21 receives an approval signal AS. In this example, it is assumed that target job information included in a target job presence notification includes attribute information 526 of the target job. It is assumed that the attribute determining process is a sex determining process.

Referring to FIG. 10, the flowchart is different from the flowchart according to the embodiment (FIG. 6) in that the processes of Steps S331 to S339B are added. Steps S305 to S330 are the same as Steps S105 to S130.

When a target job presence notification has been received (YES in Step S330), the server 21 determines whether a plurality of target jobs is present based on the notification (Step S331). When a plurality of target jobs is not present, that is, when a single target job is present, (NO in Step S331), the server 21 notifies the user U of the target job information (Step S333) and then ends the routine. On the other hand, when a plurality of target jobs is present (YES in Step S331), the routine proceeds to Step S332.

The server 21 determines whether the plurality of target jobs includes both a male job (a test play of a video game in this example) and a female job (experience of new cosmetics in this example) based on the attribute information 526 of the target job information (Step S332). When the plurality of target jobs does not include both jobs (NO in Step S332), the routine proceeds to Step S333. On the other hand, when the plurality of target jobs includes both jobs (YES in Step S332), the routine proceeds to Step S335.

The server 21 acquires a user image generated by the camera 155 from the vehicle 33 (Step S335), performs the sex determining process of determining sex of the user U based on the user image (Step S337), and switches the routine based on the result of determination (Step S338).

For example, when it is determined that the user is male, the server 21 selects a male job as the proposed job (Step S339A). On the other hand, when it is determined that the user U is female, the server 21 selects a female job as the proposed job (Step S339B). After Step S339A or Step S339B, the server 21 performs a notification process by notifying the user U of the target job information of the proposed job (Step S340).

According to Modified Example 3, a proposed job is selected based on the attributes of the user U. As a result, it is possible to notify the user of information of a target job suitable for the attributes of the user U.

### Other Modifications

The server 21 may acquire a user image generated by a camera mounted in the mobile terminal 38 from the mobile terminal 38. When there is a plurality of target jobs, the server 21 performs the attribute determining process based on the user image and selects a proposed job.

In the aforementioned embodiment and Modified Examples 1 to 3 thereof, the notification process is a process of displaying the screen 90 including the target job information on the display device 144 mounted in the vehicle 33, but may be a process of displaying the screen on the display device of the mobile terminal 38.

It should be understood that the aforementioned embodiment of the present disclosure is exemplary in all respects and is not restrictive. The scope of the present disclosure is defined by the appended claims, not by the above description and is intended to include all modifications within meanings and scopes equivalent to the claims.

What is claimed is:

1. A server configured to notify a user of a vehicle that is able to participate in demand response for adjusting electric power demand-supply balance in a power grid through external charging of charging an onboard power storage device using an electric power facility outside of the vehicle, the server comprising:
a storage device configured to store information indicating a demand-response period which is a period in which the vehicle participates in the demand response and a demand-response location which is a location of the electric power facility used for the vehicle to participate in the demand-response;
a communication device configured to communicate with a provider server that stores information indicating an execution period and an execution location of at least one job given by a provider; and
a processing device configured to perform a process of inquiring the provider server about whether the at least one job includes a target job through the communication device,
wherein the target job is a job of which the execution period is included in the demand-response period and the execution location is in a vicinity area of the demand-response location, and
wherein, when the at least one job includes the target job, the processing device is configured to perform a notification process of notifying the user of target job information indicating the execution period and the execution location of the target job.

2. The server according to claim 1, wherein the target job information includes information indicating a required time for the target job,
wherein the processing device is configured to set a command value of charging electric power of the onboard power storage device in the demand-response period, and
wherein, when the user performs the target job, the processing device is configured to set the command value to be higher when the required time is short than when the required time is long.

3. The server according to claim 1, wherein, when the user performs an operation for desiring extension of the demand-response period after starting the target job, the processing device is configured to extend the demand-response period.

4. The server according to claim 1, wherein the processing device is configured to acquire a user image generated by an imaging device that images the user from the imaging device and to perform an attribute determining process of determining attributes of the user based on the user image, and
wherein, when there is a plurality of target jobs, the processing device is configured to select a proposed job which is proposed to the user out of the plurality of target jobs based on a result of the attribute determining process and to perform the notification process by notifying the user of the target job information of the proposed job.

5. The server according to claim 1, wherein the notification process includes displaying the target job information on a display device mounted in the vehicle or a display device of a terminal device of the user.

6. A power conditioning system comprising:
a vehicle that is able to participate in demand response for adjusting electric power demand-supply balance in a power grid through external charging of charging an onboard power storage device using an electric power facility outside of the vehicle; and
a server configured to notify a user of the vehicle,
wherein the server includes:
a storage device configured to store information indicating a demand-response period which is a period in which the vehicle participates in the demand response and a demand-response location which is a location of the electric power facility used for the vehicle to participate in the demand-response;
a communication device configured to communicate with a provider server that stores information indicating an execution period and an execution location of at least one job given by a provider; and
a processing device configured to perform a process of inquiring the provider server about whether the at least one job includes a target job through the communication device,
wherein the target job is a job of which the execution period is included in the demand-response period and the execution location is in a vicinity area of the demand-response location, and
wherein, when the at least one job includes the target job, the processing device is configured to perform a notification process of notifying the user of target job information indicating the execution period and the execution location of the target job.
